(19) United States
(12) Patent Application Publication
(10) Pub. No.: US 2014/0017045 A1
(43) Pub. Date: Jan. 16, 2014

(54) STRADDLE CARRIER DEVICE COMPRISING ELECTRIC DRIVES

(71) Applicants: Armin Wieschemann, Oberhausen (DE); Mike Hegewald, Dusseldorf (DE); Jannis Moutsokapas, Monheim (DE)

(72) Inventors: Armin Wieschemann, Oberhausen (DE); Mike Hegewald, Dusseldorf (DE); Jannis Moutsokapas, Monheim (DE)

(73) Assignee: GOTTWALD PORT TECHNOLOGY GMBH, Düsseldorf (DE)

(21) Appl. No.: 14/007,877

(22) PCT Filed: Apr. 3, 2012
(86) PCT No.: PCT/EP2012/056094

§ 371 Date: Sep. 26, 2013

(30) Foreign Application Priority Data
Apr. 6, 2011 (DE) 10 2011 001 847.6
Oct. 5, 2011 (DE) 10 2011 054 209.4

(51) Int. Cl. B66C 19/00; B60K 1/04; B66C 13/12

(52) U.S. Cl. CPC B66C 19/007; B66C 13/12; B60K 1/04
USPC 414/460; 414/800

(57) ABSTRACT

A fully electric straddle carrier device for ISO containers, comprising electric drives which are powered by a replaceable battery and comprising liftable and lowerable load-receiving means for the ISO containers.

### CROSS REFERENCE TO RELATED APPLICATIONS

The present application claims the priority benefits of International Patent Application No. PCT/EP2012/056094, filed on Apr. 3, 2012, and also of German Patent Application Nos. DE 10 2011 001 847.6, filed on Apr. 6, 2011, and DE 10 2011 054 209.4, filed on Oct. 5, 2011, which are hereby incorporated herein by reference in their entireties.

### BACKGROUND OF THE INVENTION

The invention relates to a straddle carrier device for ISO-containers with electric drives which are powered via a battery, and with a load picking-up means, which can be raised and lowered, for the ISO-containers.

The invention also relates to a method for operating a straddle carrier device for ISO-containers with electric drives which are powered via a battery, and with a load picking-up means, which can be raised and lowered, for the ISO-containers.

Straddle carrier devices of this type—also known as straddle carrier stacking trolleys, straddle stacking trolleys, straddle carriers, van carriers, shuttle carriers or runners—are generally known. They are specific handling devices for ISO-containers in terminals, in particular port terminals or terminals for combined transport between road and rail. With the aid of a lifting device and a load picking-up means, designated as a spreader, straddle carrier devices can lift containers and—after transportation—set them down at a target location. Since the straddle carrier devices have a spider-leg structure, they can travel over a container resting on the floor or on another container and in so doing also—depending on construction—additionally transport a lifted container. Depending on the construction height, the straddle carrier devices are designated, for example, as 1 over 3 devices, 1 over 2 devices etc. A 1 over 3 device can set down a container on 3 stacked containers, pick up one of 3 stacked containers or travel over 3 stacked containers with a picked-up container. In this context, standardised large-size or sea freight containers which are used in the international transportation of goods are understood to be ISO-containers. The most widely used are ISO-containers with a width of 8 feet and a length of 20, 40 or 45 feet.

From international patent application WO 2009/150303 A1, a straddle carrier device for ISO-containers is already known. In the conventional manner the straddle carrier device —as seen in its direction of travel—has a right-hand travelling mechanism girder and a left-hand travelling mechanism girder. At least two rubber-tyred and steerable tyre-mounted travelling mechanisms disposed one behind the other in the direction of travel are attached to each travelling mechanism girder. The right-hand and the left-hand travelling mechanism girders are connected to each other via a front and a rear gantry frame. In the region of their upper ends, the two gantry frames are connected to each other via an upper frame. A lifting device is suspended on the upper frame and from it a load picking-up means for the ISO-containers can be raised and lowered. The straddle carrier device is fully electric and therefore has electric travel drives, electric steering drives and electric lifting drives. These drives are powered via an on-board rechargeable battery. The charging process for the battery is effected at a charging station which is disposed in the region of a stacking area for containers.

Furthermore, from German utility model document DE 20 2004 018 066 U1, a further straddle carrier device is known which is driven by a diesel-electric drive. In the conventional manner, this straddle carrier device also has a front and rear gantry frame which are connected to each other via an upper frame. The diesel-electric drive is disposed in the region of the upper frame and above a load picking-up means for containers.

International patent application WO 2007/143841 A1 discloses a gantry crane which is operated via a hybrid drive. The hybrid drive includes an internal combustion engine and a battery which is fixedly mounted in the gantry crane.

European patent application EP 2 354 075 A1 discloses a gantry crane which is operated via two batteries fixedly mounted in the gantry crane. The batteries can be charged in a contactless manner via a power supply system, wherein provision is made that one of the batteries can be charged whilst the other is still being discharged by the operation of the gantry crane.

Battery-operated straddle carrier devices, in which the batteries are fixedly mounted, are also known from Japanese patent application JP 2008 156047 A as well as patent document U.S. Pat. No. 6,155,770 A.

Furthermore, European patent application EP 2 281 769 A2 discloses a manually operable straddle carrier device and German patent document DE 10 2008 011 539 B3 discloses a fully-automatic straddle carrier device.

### SUMMARY OF THE INVENTION

The present invention provides an improved, fully electric straddle carrier device.

In accordance with the invention an improved straddle carrier device for ISO-containers with electric drives, which are powered via a battery, and with a load picking-up means, which can be raised and lowered, for the ISO-containers is provided, whereby, in order to charge the battery outside the straddle carrier device, the battery is releasably connected to the straddle carrier device and can be replaced in conjunction with the charging process. This battery is advantageously connected to the straddle carrier device in a replaceable manner. It is therefore particularly easy to replace a battery which needs to be charged with a charged battery, without the availability of the straddle carrier device being limited for a charging process as in the case of a non-replaceable battery. The replacement process can be carried out manually, semi-automatically or fully automatically. The charging process for the battery thus takes place outside of the straddle carrier device. The electric drives in the form of electric motors act in a conventional manner via gearing on the components to be driven in order to fulfil the drive functions provided in the straddle carrier device such as, for example, travel drive, braking drive, steering drive and lifting drive. For specific drive functions such as, for example, the steering drive or the lifting drive it may be necessary to drive a hydraulic pump via the electric drive in order to design the steering drive or the lifting drive in an electro-hydraulic manner. The selected battery-electric drive has the advantage that a degree of effectiveness is achieved which is approximately more than double that of a diesel engine. This leads to a lower level of power consumption, increased efficiency, lower maintenance and a high level of environmental compatibility especially in relation to noise and emissions.

Provision is made that only purely electric drives, i.e., no electro-hydraulic drives, are provided, which means that the straddle carrier device does not need hydraulic components.

By arranging the battery above the load picking-up means, the space available there is optimally used in order to house a high-capacity battery of appropriate size.

In a particular embodiment, provision is made that the straddle carrier device has a front gantry frame and a rear gantry frame which are connected to each other in the region of their upper ends via an upper frame, and the battery is disposed in the region of the upper frame.

Alternatively, in particular in the case of high straddle carrier devices, provision can be made that the battery is disposed in the region of wheel-mounted travelling mechanisms of the straddle carrier device.

A high level of reliability for the straddle carrier device is achieved in that the battery is a lead-acid battery. Lead-acid batteries have been used in vehicles for many years. The battery required has a weight of about 6 to 10 metric tons (“t”).

In a particular embodiment, provision is made that the battery has a supporting function within the straddle carrier device. This embodiment is particularly space-saving since the supporting construction in the region of the upper frame and the battery merge with each other in terms of their function.

The straddle carrier device is designed as a 1 over 1 construction and preferably as a 1 over 0 construction. By means of the 1 over 0 construction only low lifting efforts are required because of the low lifting height. The 1 over 0 construction also leads to a low centre of gravity which permits a compact and also simple construction for the straddle carrier device. Since the straddle carrier device has a low centre of gravity and therefore has a high level of stability and resistance to tipping, it is able to travel on only four tyre-mounted travelling mechanisms with rubber tyres. The limitation to four tyre-mounted travelling mechanisms also makes it possible to reduce the complexity of the straddle carrier device as a whole. Driving and steering can be rendered simpler. In the case of an automatically guided straddle carrier device, navigation also becomes simpler.

In a preferred embodiment the straddle carrier device is automatically guided.

Alternatively, provision is made that a driver's cabin is disposed on the straddle carrier device and the straddle carrier device can be driven manually.

A method for operating a straddle carrier device for ISO-containers with electric drives, which are powered via a battery, and with a load picking-up means, which can be raised and lowered, for the ISO-containers is improved by virtue of the fact that a flat battery is replaced with a charged battery.

The method is further improved by virtue of the fact that for replacement purposes, the battery is moved out of and into the straddle carrier device horizontally and transverse to the direction of travel thereof.

The invention will be explained in more detail hereinafter with the aid of an exemplified embodiment illustrated in the drawings.

### BRIEF DESCRIPTION OF THE DRAWINGS

FIG. 1 shows a schematic side view of a first embodiment of a straddle carrier device,

FIG. 2 shows a schematic side view of a second embodiment of a straddle carrier device, and

FIG. 3 shows a plan view of a port layout with the straddle carrier devices in accordance with FIG. 1 or 2.

### DESCRIPTION OF THE PREFERRED EMBODIMENTS

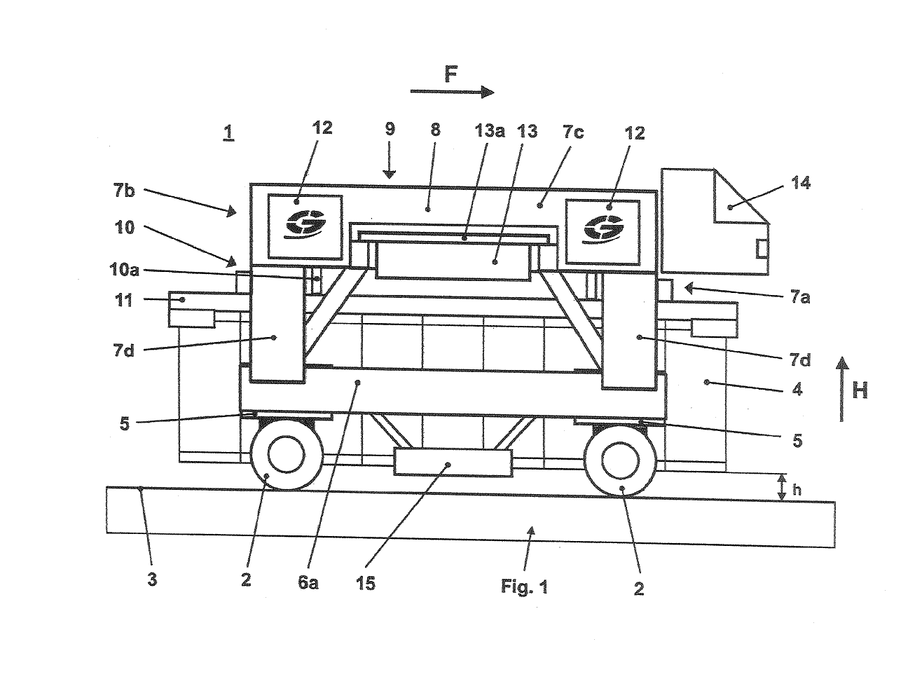

FIG. 1 shows a schematic side view of a straddle carrier device 1 which can travel via a total of four rubber-tyred wheels 2 on a ground surface 3. The wheels 2 are disposed in the conventional manner in the corners of an imaginary rectangle. It is also fundamentally possible to provide more than four rubber-tyred wheels 2 if this is required for technical reasons. However, this is then associated with an increase in the complexity of the straddle carrier device 1 as a whole and therefore more complex technology must be used in the area of driving and steering. In the case of automatically guided straddle carrier devices 1, navigation also becomes more complex owing to the increase in wheels 2 to be steered.

The wheels 2 of the straddle carrier device 1 are component parts of wheel-mounted travelling mechanisms 5 which have electric travel drives and electric steering motors, not shown. The individual wheel steering provided means it is possible, with appropriate control, to carry out different steering programmes, such as for example optimised Ackermann steering or backwards movement. Out of the total of four wheel-mounted travelling mechanisms 5, in each case two—in a spaced relationship and one behind the other as seen in the direction of travel F of the straddle carrier device 1—are attached to a right-hand travelling mechanism girder 6a and to a left-hand travelling mechanism girder which is concealed by the right-hand one, which are each oriented with their longitudinal extension in the direction of travel F of the straddle carrier device 1. The two travelling mechanism girders 6a which are disposed in parallel next to each other and in a mutually spaced manner are connected to each other at the front via a front gantry frame 7a and at the rear via a rear gantry frame 7b. Each of the two u-shaped gantry frames 7a and 7b consists of a horizontal upper gantry girder 7c oriented transverse to the direction of travel F, the lateral ends of which are each adjoined by a vertical gantry support 7d. The front and rear gantry frames 7a, 7b are connected to each other via longitudinal girders 8 oriented in the direction of travel F.

The two gantry girders 7c and the longitudinal girders 8 form an upper frame 9 on which a lifting apparatus 10 is suspended in order to be able to pick up the ISO-containers 4 from the ground 3 and to set them down on the ground 3. The lifting height h required for this purpose is about 150 to 300 mm. The lifting apparatus 10 includes one or a plurality of electric lifting drives, not shown, which are connected to a load picking-up means 11 via cables or a lifting mechanism 10a. The load picking-up means 11 is designed as a so-called spreader frame in order to be able to handle ISO-containers 4. The spreader frames are designed as so-called single-lift or twin-lift spreaders, i.e., in the twin-lift version, two 20 foot ISO-containers 4 can be picked up one after the other as seen in the direction of travel F of the straddle carrier device 1. In a conventional manner the load picking-up means 11 is able to move up and down below the upper frame 9 and between the gantry supports 7d of the front gantry frame 7a and the gantry supports 7d of the rear gantry frame 7b in an essentially vertical lifting direction H.

Furthermore, in the region of the upper frame 9 sufficient space is available to house switch cabinets 12 and one or a plurality of batteries 13. A high level of reliability in the heavy goods transport vehicle is achieved by the battery 13 being a lead-acid battery. Lead-acid batteries have been used in vehicles for many years. The weight of the battery is in the range of about 6 to 10 t, preferably 8 to 9 t. Furthermore, provision is made so that a flat battery 13 can be replaced by a charged battery 13 and can be moved by an appropriate apparatus, transverse to the direction of travel F, horizontally out of the upper frame 9 or into this upper frame. The charging process for the battery 13 therefore takes place outside the straddle carrier device 1 and the straddle carrier device 1 is available immediately after the battery has been replaced. The replacement process can be carried out manually, semi-automatically or fully automatically.

It is also possible in an alternative embodiment to dispose the replaceable batteries 13 between the gantry supports 7d of the front gantry frame 7a and the gantry supports 7d of the lower gantry frame 7b, as seen in the direction of travel F, and at the height of the wheel-mounted travelling mechanisms 5. For reasons of weight distribution, two batteries 13 are provided which are disposed, as seen in the direction of travel F, on the right and left next to an ISO-container 4 to be transported. The batteries 13 are also suspended on the travelling mechanism girders, of which only the right-hand travelling mechanism girder 6a is shown. For this, the travelling mechanism girder can also be additionally recessed on the lower side thereof.

If, in the next few years, other types of battery, such as, for example, lithium-ion batteries, achieve an equivalent level of reliability to lead-acid batteries, it will also be possible to use them.

As a whole, the straddle carrier device 1, in particular the lifting height of the lifting apparatus 10, is designed as a so-called 1 over 0 device, i.e., by means of the straddle carrier device 1 a single ISO-container 4 can be picked up from the ground 3 and set down. Stacking of ISO-containers 4 is not possible. With an appropriately designed load picking-up means 11 (twin-lift) it is naturally possible to pick up together two ISO-containers 4 which are disposed one behind the other as seen in the direction of travel F and have a length of 20 feet each. By means of this embodiment as a 1 over 0 device, the straddle carrier device 1 has a low centre of gravity, a good level of stability and the construction can be extremely compact. The demands placed on the performance of the electric lifting drives are also not so great. Furthermore, the construction height is low and consequently the weight is light, which means that four wheels suffice to receive the load.

Furthermore, the straddle carrier device 1 can be controlled manually by a driver or be guided automatically. For the manual version, a driver's cabin 14 is attached in the region of the front gantry frame 7a. In the case of the automatically guided version, sufficient space for sensors 15 is provided in the region below the travelling mechanism girders 6a and between the front and rear wheel-mounted travelling mechanisms 5 respectively, the sensors being designed according to the navigation system used. If transponders let into the ground 3 are used then the sensors 15 are designed as antennas.

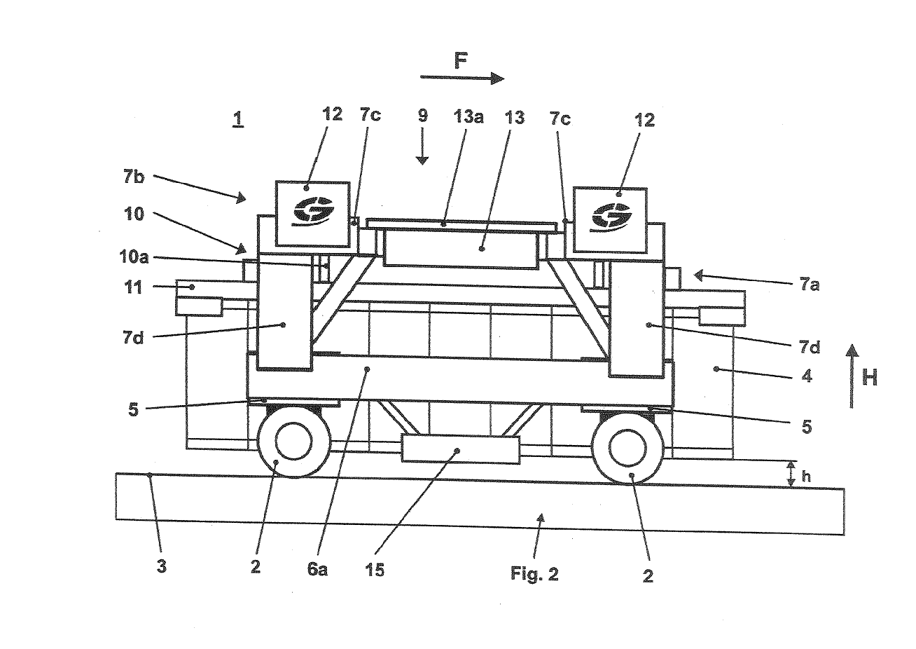

FIG. 2 shows a schematic side view of a second embodiment of a straddle carrier device 1. This straddle carrier device 1 corresponds essentially to the straddle carrier device 1 described above, which means that reference is made to the entire content of the preceding description. The same reference numbers as in FIG. 1 have also been used.

In this second embodiment, the battery 13 or the receiving frame 13a thereof is designed as a supporting component which provides the upper frame 9 with sufficient solidity during operation of the straddle carrier device 1. For this purpose the battery 13 is additionally secured, for example by bolts, after its insertion into the straddle carrier device 1. The battery 13 also has an appropriately arranged battery frame 13a in order to be able to absorb the forces resulting from the operation of the straddle carrier device 1 between the front and rear gantry frames 7a, 7b. Although in conjunction with the replacement of the battery 13 the upper frame 9 is then weakened without the battery 13, the upper frame 9 does have sufficient solidity during the time the straddle carrier device 1 is waiting for a new charged battery 13.

For the automatic guided version, in the region below the travelling mechanism girders 6a and between the front and rear wheel-mounted travelling mechanisms 5 respectively there is sufficient space for sensors 15 which are designed according to the type of navigation system used. If transponders let into the ground 3 are used, the sensors 15 are designed as antennas. In conjunction with the automated guided version, fully automatic object-recognition for the containers 4 to be picked up can also be provided. Since the positions of the containers 4 on the quay 16 are approximately known, the straddle carrier device 1 can navigate its way thereto independently. Prior to reaching the final position the containers 4 are passed over by an object-recognition sensor arrangement and the straddle carrier device 1 can be finely positioned from the position data thereby obtained. The containers 4 are then picked up.

This arrangement is also feasible for an arrangement of the batteries 13 in the region of the travelling mechanism girders 6a.

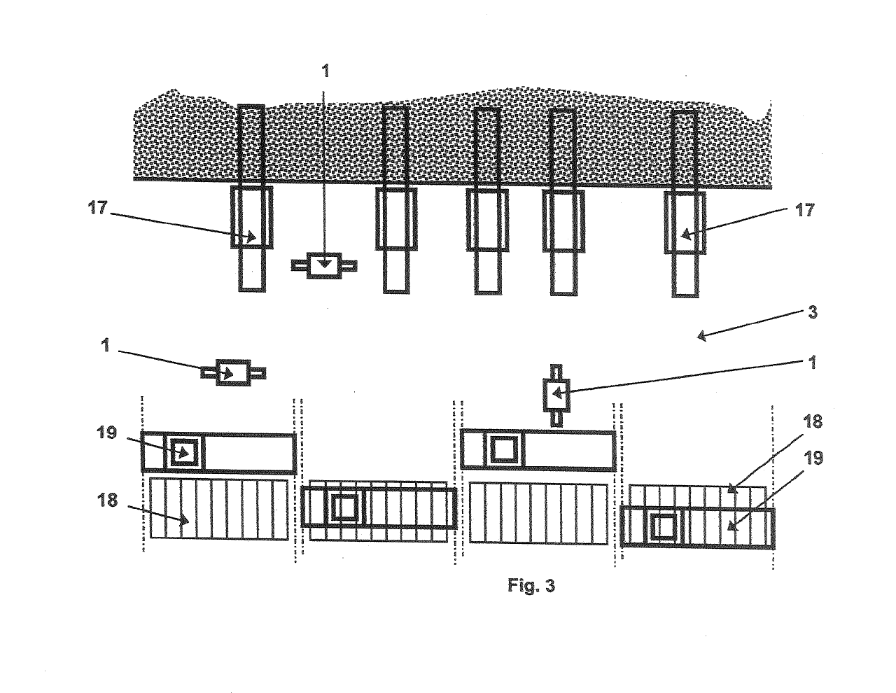

FIG. 3 shows a plan view of a port layout using the straddle carrier devices 1 described above as shown in FIG. 1 or 2. The ground surface 3 is a component part of a quay 16 over which—by means of a large number of straddle carrier devices 1—the ISO-containers 4 are moved by container stacking cranes 19 between a plurality of container crane bridges 17 and a container stacking area 18 adjoining the quay 16. Instead of the container-handling crane bridges it is naturally also possible to use other handling devices such as, for example, mobile port cranes, in particular in the case of smaller handling ports.

Furthermore, provision can be made, or it may be technically necessary, to resort to electro-hydraulic drives instead of purely electric drives, which act on gears, for certain drive functions such as steering or lifting. It is also possible in the case of the straddle carrier devices 1 to provide for energy recovery when the ISO-containers 4 are being lowered or the straddle carrier device 1 is being braked. The recovered energy is then stored in short-term energy stores such as so-called ultracaps or supercaps.

### LIST OF REFERENCE NUMERALS

1 Straddle carrier device
2 Wheel
3 Ground surface
4 ISO-container
5 Wheel-mounted travelling mechanism
6a Right-hand travelling mechanism girder
7a Front gantry frame
7b Rear gantry frame
7c Upper gantry girder
7d Gantry support
8 Longitudinal girder
9 Upper frame
10 Lifting apparatus
10a Lifting mechanism
11 Load picking-up means
12 Switch cabinet
13 Battery
14 Driver's cabin
15 Sensor
16 Quay
17 Container bride crane
19 Container stacking area
19 Container stacking crane
F Direction of travel
H Lifting direction
h Lifting height

1. Straddle carrier device for ISO-containers with electric drives which are powered via a battery, and with a spreader, which can be raised and lowered, for the ISO-containers, wherein, in order to charge the battery outside the straddle carrier device, the battery is releasably connected to the straddle carrier device and can be replaced in conjunction with the charging process.

2. Straddle carrier device as claimed in claim 1, wherein only electric drives are provided.

3. Straddle carrier device as claimed in claim 2, wherein the battery is disposed above the spreader.

4. Straddle carrier device as claimed in claim 3, wherein the straddle carrier device has a front gantry frame and a rear gantry frame which are connected to each other in the region of their upper ends via an upper frame, and the battery is disposed in the region of the upper frame.

5. Straddle carrier device as claimed in claim 2, wherein the battery is disposed in the region of wheel-mounted travelling mechanisms of the straddle carrier device.

6. Straddle carrier device as claimed in claim 4, wherein the battery is a lead-acid battery and has a weight of about 6 to 10 metric tons (“t”).

7. Straddle carrier device as claimed in claim 4, wherein the battery has a supporting function within the straddle carrier device.

8. Straddle carrier device as claimed in claim 4, wherein the straddle carrier device is designed in a 1 over 0 construction.

9. Straddle carrier device as claimed in claim 4, wherein the straddle carrier device is designed in a 1 over 1 construction.

10. Straddle carrier device as claimed in claim 4, wherein the straddle carrier device is automatically guided.

11. Straddle carrier device as claimed in claim 4, wherein a driver's cabin is disposed on the straddle carrier device and the straddle carrier device can be driven manually.

12. (canceled)

13. (canceled)

14. Straddle carrier device as claimed in claim 1, wherein the battery is disposed above the spreader.

15. Straddle carrier device as claimed in claim 14, wherein the straddle carrier device has a front gantry frame and a rear gantry frame which are connected to each other in the region of their upper ends via an upper frame, and the battery is disposed in the region of the upper frame.

16. Straddle carrier device as claimed in claim 1, wherein the straddle carrier device has a front gantry frame and a rear gantry frame which are connected to each other in the region of their upper ends via an upper frame, and the battery is disposed in the region of the upper frame.

17. Straddle carrier device as claimed in claim 2, wherein the straddle carrier device has a front gantry frame and a rear gantry frame which are connected to each other in the region of their upper ends via an upper frame, and the battery is disposed in the region of the upper frame.

18. Straddle carrier device as claimed in claim 1, wherein the battery is disposed in the region of wheel-mounted travelling mechanisms of the straddle carrier device.

19. Straddle carrier device as claimed in claim 1, wherein the battery is a lead-acid battery and has a weight of about 6 to 10 t.

20. Straddle carrier device as claimed in claim 1, wherein the battery has a supporting function within the straddle carrier device.

21. Straddle carrier device as claimed in claim 1, wherein a driver's cabin is disposed on the straddle carrier device and the straddle carrier device can be driven manually.

22. Method for operating a straddle carrier device for ISO-containers with electric drives, which are powered via a battery, and with a spreader, which can be raised and lowered, for the ISO-containers, wherein a flat battery is replaced with a charged battery.

23. Method as claimed in claim 22, wherein for replacement purposes, the battery is moved out of and into the straddle carrier device horizontally and transverse to the direction of travel thereof.
